(19) United States
(12) Patent Application Publication
(10) Pub. No.: US 2007/0046801 A1
(43) Pub. Date: Mar. 1, 2007

(54) XY ADDRESS TYPE SOLID-STATE IMAGING DEVICE

(75) Inventors: Shigetaka KASUGA, Osaka (JP); Takumi YAMAGUCHI, Kyoto (JP); Takahiko MURATA, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Osaka (JP)

(21) Appl. No.: 11/463,693

(22) Filed: Aug. 10, 2006

(30) Foreign Application Priority Data
Aug. 23, 2005 (JP) JP2005-241419
Aug. 23, 2005 (JP) JP2005-241420
Sep. 29, 2005 (JP) JP2005-284940

(51) Int. Cl. H04N 5/335

(52) U.S. Cl. 348/308

(57) ABSTRACT

A plurality of pixels that are arranged two-dimensionally, a horizontal scanning circuit and a vertical scanning circuit that output a signal for reading out an accumulated charge in the pixel, and a multiplexer circuit that supplies a control signal to elements constituting each of the pixels based on the signal outputted from the vertical scanning circuit are provided. The vertical scanning circuit is used singly to output a scanning signal for reading out the accumulated charge and a scanning signal for clearing the accumulated charge in the pixel, and the multiplexer circuit is used singly to supply an accumulated charge readout signal and an accumulated charge clearing signal as the control signal based on the scanning signal for reading out the accumulated charge and the scanning signal for clearing the accumulated charge. One vertical scanning circuit is used for both scanning for reading out an accumulated charge and scanning for clearing the accumulated charge, and one multiplexer is used for outputting both an accumulated charge readout signal and an accumulated charge clearing signal, thus allowing a reduction of a chip area and an improvement in an operation yield.

### BACKGROUND OF THE INVENTION

1. Field of the Invention

The present invention relates to an XY address type solid-state imaging device including a plurality of pixels that are arranged two-dimensionally and horizontal and vertical scanning circuits for reading out accumulated charges in the pixels. In particular, the present invention relates to an improvement for allowing circuit miniaturization by making it possible to use one vertical scanning circuit for both scanning for reading out the accumulated charge and scanning for clearing the accumulated charge and to use one multiplexer for outputting both an accumulated charge readout signal and an accumulated charge clearing signal.

2. Description of Related Art

As a circuit of MOS image sensors among solid-state imaging devices, a circuit with a configuration illustrated in FIG. 5 of JP 2003-46864 A, for example, has been known. FIG. 16 is a block circuit diagram showing a MOS image sensor circuit in a conventional example similar to that described in the above-mentioned document.

In FIG. 16, each pixel arranged in a pixel portion 1 includes a photodiode PD, a transfer transistor TRa, a reset transistor TRb, an amplification transistor TRc and a row selection transistor TRd. Each pixel portion 1 is supplied with a control pulse from an electric charge readout multiplexer circuit 2, an electronic shutter multiplexer circuit 3, a vertical line scanning circuit 4 and an electronic shutter scanning circuit 5, thereby controlling readout of an electric charge generated from the photodiode PD in each pixel in the pixel portion 1. The readout electric charge is processed by a noise canceller circuit 6 and then supplied to an output amplifier 8 based on an operation of a horizontal line scanning circuit 7. A timing generating circuit 9 generates a source power supply voltage signal SCEL, a load gate signal LGCEL and a sample hold pulse SHNC and supplies them to the pixel portion 1 and also controls a generation timing of a transfer pulse TRAN, a reset pulse RESET, a transfer pulse ETRAN at the time of electronic shutter operation, a reset pulse ERESET at the time of electronic shutter operation and a row selection signal VSEL.

For an operation of reading out an accumulated charge in the pixel, the reset pulse RESET is outputted to the reset transistor TRb, the transfer pulse TRAN is outputted to the transfer transistor TRa and the row selection signal VSEL is outputted to the row selection transistor TRd via the vertical line scanning circuit 4 and the electric charge readout multiplexer circuit 2, etc. Also, for an operation of clearing the accumulated charge in the pixel, the reset pulse ERESET at the time of electronic shutter operation is outputted to the reset transistor TRb and the transfer pulse ETRAN at the time of electronic shutter operation is outputted to the transfer transistor TRa via the electronic shutter scanning circuit 5 and the electronic shutter multiplexer circuit 3, etc.

FIG. 17 shows an operation timing of the solid-state imaging device of FIG. 16. At time TO, a predetermined constant voltage is applied as the load gate signal LGCEL. At time T1, the row selection signal VSEL and the reset pulse RESET are turned ON, thus clearing the charge in the photodiode PD. When the reset pulse RESET is turned OFF at time T2, a reference voltage of a pixel signal is outputted, thus clamping a reset level of a pixel signal V0. At time T3, the transfer pulse TRAN is turned ON so as to transfer the accumulated charge in the photodiode PD. When the transfer pulse TRAN is turned OFF at time T4, an electric potential based on an accumulated charge signal in the pixel is outputted. During a period in which the sample hold pulse SHNC is ON (at times T1 to T5), the signals of these electric potentials are transmitted to the noise canceller circuit 6 in FIG. 16.

Next, at time T7, the reset pulse ERESET at the time of electronic shutter operation is turned ON while the row selection signal VSEL is kept OFF. At time T8, it is turned OFF. At time T9, the transfer pulse ETRAN at the time of electronic shutter operation is turned ON, and then, at time T10, it is turned OFF, thereby clearing the accumulated charge signal in the pixel and dumping it to a power supply VDD (see FIG. 16).

As described above, each signal for reading out the accumulated charge in the pixel is generated by the combination of the vertical line scanning circuit 4 and the electric charge readout multiplexer circuit 2, and each signal for clearing the accumulated charge in the pixel is generated by the combination of the electronic shutter scanning circuit 5 and the electronic shutter multiplexer circuit 3.

The following is a specific description of the operation of the MOS image sensor circuit shown in FIG. 16. FIG. 18 illustrates an example of a shift register constituting the vertical line scanning circuit 4 or the electronic shutter scanning circuit 5. FIG. 19 shows the operation timing. First, a second scan pulse V2 is turned ON at time To and turned OFF at time T1. In this way, a capacitor C01 in FIG. 18 is charged by the power supply VDD by a GND reference via transistors TR01 and TR02. At time T2, a first scan pulse V1 and a shift start pulse ST are turned ON. Since this boosts the capacitor C01, the shift start pulse ST charges a capacitor C02 without being attenuated due to a threshold voltage of a transistor TR1. After the shift start pulse ST is turned OFF at time T3, a capacitor C02 is boosted. Therefore, the first scan pulse V1 is outputted as an SIG1 pulse without being attenuated due to a threshold voltage of a transistor TR2. The SIG1 pulse is outputted until the first scan pulse V1 is turned OFF at time T4. Incidentally, since the capacitor C02 is boosted at time T3, a capacitor C03 at the subsequent stage is charged by the power supply VDD without being attenuated due to a threshold voltage of a transistor TR3.

When the second scan pulse V2 is turned ON at time T5, the second scan pulse V2 is outputted as an SIG2 pulse without being attenuated due to a threshold voltage of a transistor TR4. The SIG2 pulse is supplied to a transistor TR04 at the first stage, thus discharging an electric charge of the capacitor C02. Hereafter, SIG pulses are outputted sequentially from the shift register in synchronization with the first scan pulse VI and the second scan pulse V2 in a similar manner.

FIG. 20 shows respective shift registers constituting the vertical line scanning circuit 4 and the electronic shutter scanning circuit 5, the electric charge readout multiplexer circuit 2 and the electronic shutter multiplexer circuit 3 in the MOS image sensor circuit shown in FIG. 16. As the shift registers, vertical shift registers 4a to 4c at respective stages of the vertical line scanning circuit 4 and shutter shift registers 5a to 5c at respective stages of the electronic shutter scanning circuit 5 are illustrated. An output of each stage of the shift registers is supplied via a transistor TR5 to the electric charge readout multiplexer circuit 2 and the electronic shutter multiplexer circuit 3.

By the combination of the SIG1 to SIG3 pulses sequentially outputted from the vertical shift registers 4a to 4c and the electric charge readout multiplexer circuit 2, the reset pulse RESET, the transfer pulse TRAN and the row selection signal VSEL are generated and transmitted to the pixel. Similarly, by the combination of ESIG1 to ESIG3 pulses sequentially outputted from the shutter shift registers 5a to 5c and the electronic shutter multiplexer circuit 3, the reset pulse ERESET and the transfer pulse ETRAN are generated and transmitted to the pixel.

FIGS. 21A and 21B show operation timings of the circuits of FIG. 20. FIG. 21A shows the operation timings of the shift registers, and FIG. 21B shows the operation timing of the multiplexer circuit. Incidentally, although the same time signs are provided in FIGS. 21A and 21B, they do not necessarily mean the same time. The period of a SIG/ESIG waveform shown on the top of FIG. 21B corresponds to a period of a single SIG/ESIG pulse in FIG. 21A. In FIG. 21A, VST indicates a shift start pulse for charge readout inputted to the vertical shift register 4, and SHTST indicates a start pulse for charge clearing inputted to the electronic shutter scanning circuit 5. In FIG. 21B, VDRV indicates a vertical driver pulse. Since the operation timings of the shift registers shown in FIG. 21A are similar to that shown in FIG. 19, the description thereof will be omitted.

In the operation timing of the multiplexer circuit, the operation of the combination of the vertical shift registers 4a to 4c and the electric charge readout multiplexer circuit 2 will be described first. At time T0, the SIG1 pulse and the vertical driver pulse VDRV are turned ON, so that capacitors C10, C11 and C12 are charged by an electric potential of the SIG1 pulse. After the vertical driver pulse VDRV is turned OFF at time T1, the reset pulse RESET and the row selection signal VSEL are turned ON at time T2. Since this boosts the capacitors C10 and C12, the reset pulse RESET and the row selection signal VSEL are transmitted to the pixel portion without being attenuated due to threshold voltages of transistors TR10 and TR12. After the reset pulse RESET is turned OFF at time T3, a reference electric potential of the signal of the pixel is outputted. When the transfer pulse TRAN is turned ON at time T4, it is transmitted to the pixel portion without being attenuated due to a threshold voltage of a transistor TR11. When the transfer pulse TRAN is turned OFF at time T5, an electric potential based on an accumulated charge signal in the pixel is outputted. During a period in which the sample hold pulse SHNC is ON (at times T2 to T6), these signals are transmitted to the noise canceller circuit 6 in FIG. 16. This completes the operation of reading out an accumulated signal in the pixel arranged in the first row. A similar operation applies to the other rows.

Next, the operation of the combination of the shutter shift registers 5a to 5c and the electronic shutter multiplexer circuit 3 will be described. At time T0, the ESIG1 pulse and the vertical driver pulse VDRV are turned ON, so that an electric potential of the ESIG1 pulse is charged to capacitors C13 and C14. After the vertical driver pulse VDRV is turned OFF at time T1, the reset pulse ERESET is turned ON at time T8, and this boosts the capacitor C13. Accordingly, the reset pulse ERESET is transmitted to the pixel portion without being attenuated due to a threshold voltage of a transistor TR13. After the reset pulse ERESET is turned OFF at time T9 and the transfer pulse ETRAN is turned ON at time T10, the transfer pulse ETRAN is transmitted to the pixel portion without being attenuated due to a threshold voltage of a transistor TR14. This completes the operation of clearing and dumping an accumulated charge signal in the pixel arranged in the first row to the power supply. A similar operation applies to the other rows.

Now, another configuration of a conventional MOS image sensor circuit will be described with reference to FIG. 22. This circuit has a configuration in which three transistors constitute each pixel of a pixel portion la and a drain line of the pixel portion la is supplied not with the power supply but with a common power supply voltage pulse VDDCEL. This makes it possible to read out an accumulated charge in the pixel without using the row selection signal VSEL in FIG. 16. Elements that are the same as those in FIG. 16 are given the same reference numerals, and the description thereof will not be repeated.

FIG. 23 shows an operation timing of the MOS image sensor circuit shown in FIG. 22. At time T0, the common power supply voltage pulse VDDCEL, the load gate signal LGCEL and the reset pulse RESET are turned ON. At time T1 when the reset pulse RESET is turned OFF, a reference electric potential of a pixel signal is outputted. When the transfer pulse TRAN is turned ON at time T2 and turned OFF at time T3, an electric potential based on an accumulated charge signal in the pixel is outputted. During a period in which the sample hold pulse SHNC is ON, the signals of these electric potentials are transmitted to the noise canceller circuit 6 in FIG. 22.

Subsequently, at time T4, the load gate signal LGCEL is turned OFF, and the common power supply voltage pulse VDDCEL is turned OFF. At times T5 and T6, the reset pulse RESET is turned ON and OFF, thus deselecting the row. Thereafter, the reset pulse ERESET at the time of electronic shutter operation is turned ON and OFF at times T7 and T8 while the load gate signal LGCEL is kept OFF, and the transfer pulse ETRAN at the time of electronic shutter operation is turned ON and OFF at times T9 and T10, thereby clearing the accumulated charge signal in the pixel.

As described above, each signal for reading out the accumulated charge in the pixel is generated by the combination of the vertical line scanning circuit 4 and an electric charge readout multiplexer circuit 2a, and each signal for clearing the accumulated charge in the pixel is generated by the combination of the electronic shutter scanning circuit 5 and the electronic shutter multiplexer circuit 3.

FIG. 24 shows respective shift registers constituting the vertical line scanning circuit 4 and the electronic shutter scanning circuit 5, the electric charge readout multiplexer circuit 2a and the electronic shutter multiplexer circuit 3 in the MOS image sensor circuit shown in FIG. 22. Elements that are similar to those in the shift registers and the multiplexer circuit shown in FIG. 20 are given the same reference numerals, and the description thereof will not be repeated.

By the combination of the SIG1 to SIG3 pulses sequentially outputted from the vertical shift registers 4a to 4c and the multiplexer circuit 2a, the reset pulse RESET and the transfer pulse TRAN are transmitted to the pixel. Similarly, by the combination of ESIG1 to ESIG3 pulses sequentially outputted by the shutter shift registers 5a to 5c and the electronic shutter multiplexer circuit 3, the reset pulse ERESET and the transfer pulse ETRAN are transmitted to the pixel.

FIGS. 25A and 25B show operation timings of the circuits of FIG. 24. FIG. 25A shows the operation timings of the shift registers, and FIG. 25B shows the operation timing of the multiplexer circuit. The operation timings of the shift registers shown in FIG. 25A are similar to that shown in FIG. 19, and the description thereof will not be repeated.

In the operation timing of the multiplexer shown in FIG. 25B, the operation of the combination of the vertical shift registers 4a to 4c and the electric charge readout multiplexer circuit 2a will be described first. At time T0, the SIG1 pulse and the vertical driver pulse VDRV are turned ON, so that an electric potential of the SIG1 pulse is charged in capacitors C20 and C21. After the vertical driver pulse VDRV is turned OFF at time T1, the reset pulse RESET and the common power supply voltage pulse VDDCEL are turned ON at time T2, and this boosts the capacitor C20. Accordingly, the reset pulse RESET is transmitted to the pixel portion without being attenuated due to a threshold voltage of a transistor TR20. After the reset pulse RESET is turned OFF at time T3, a reference electric potential of the signal of the pixel is outputted. When the transfer pulse TRAN is turned ON at time T4, the capacitor C21 is boosted. Therefore, the transfer pulse TRAN is transmitted to the pixel portion without being attenuated due to a threshold voltage of a transistor TR21. When the transfer pulse TRAN is turned OFF at time T5, an electric potential based on an accumulated charge signal in the pixel is outputted. During a period in which the sample hold pulse SHNC is ON (at times T2 to T6), the signals of these electric potentials are transmitted to the noise canceller circuit 6 in FIG. 22. At times T7 and T8, the reset pulse RESET is turned ON and OFF while the common power supply voltage pulse VDDCEL is OFF, thus ending the operation of selecting this row. This completes the operation of reading out an accumulated signal in the pixel arranged in the first row. A similar operation applies to the other rows.

Next, the operation of the combination of the shutter shift registers 5a to 5c and the electronic shutter multiplexer circuit 3 will be described. At time T0, the ESIG1 pulse and the vertical driver pulse VDRV are turned ON, so that an electric potential of the ESIG1 pulse is charged to capacitors C22 and C23. After the vertical driver pulse VDRV is turned OFF at time T1, the reset pulse ERESET is turned ON at time T9, and this boosts the capacitor C22. Accordingly, the reset pulse ERESET is transmitted to the pixel portion without being attenuated due to a threshold voltage of a transistor TR22. After the reset pulse ERESET is turned OFF at time T10 and the transfer pulse ETRAN is turned ON at time T11, the transfer pulse ETRAN is transmitted to the pixel portion without being attenuated due to a threshold voltage of a transistors TR23. At time T14, the reset pulse ERESET is turned ON and OFF while the common power supply voltage pulse VDDCEL is OFF, thus ending the operation of selecting this row. This completes the operation of clearing and dumping an accumulated charge signal in the pixel arranged in the first row to the power supply. A similar operation applies to the other rows.

In the conventional solid-state imaging device with either of the above-described circuit configurations, it has been necessary to provide two kinds of shift registers, namely, the vertical shift registers for reading out an accumulated charge in a pixel and the shutter shift registers for clearing an accumulated charge, and two kinds of multiplexer circuits, namely, the multiplexer circuit for reading out an accumulated charge in a pixel and the electronic shutter multiplexer circuit for clearing an accumulated charge. This has required a large circuit area and led to a lower yield caused by malfunction of the shift registers or the multiplexer circuits.

### SUMMARY OF THE INVENTION

The present invention was made with the foregoing problems in mind, and the object of the present invention is to provide an XY address type solid-state imaging device allowing a reduction of a chip area and an improvement in an operation yield by making it possible to use one shift register for both scanning for reading out an accumulated charge and scanning for clearing the accumulated charge, and to use one multiplexer for outputting both an accumulated charge readout signal and an accumulated charge clearing signal.

In order to achieve the above-mentioned object, an XY address type solid-state imaging device according to the present invention includes a plurality of pixels that are arranged two-dimensionally, a horizontal scanning circuit and a vertical scanning circuit that output a signal for reading out an accumulated charge in the pixel, and a multiplexer circuit that supplies a control signal to elements constituting each of the pixels based on the signal outputted from the vertical scanning circuit. The vertical scanning circuit is used singly to output a scanning signal for reading out the accumulated charge and a scanning signal for clearing the accumulated charge in the pixel, and the multiplexer circuit is used singly to supply an accumulated charge readout signal and an accumulated charge clearing signal as the control signal based on the scanning signal for reading out the accumulated charge and the scanning signal for clearing the accumulated charge.

### BRIEF DESCRIPTION OF THE DRAWINGS

FIG. 1 is a block diagram showing a MOS image sensor circuit according to Embodiment 1 of the present invention.

FIG. 2 is a circuit diagram showing specific configurations of a shutter-vertical line scanning circuit and a shutter-multiplexer circuit constituting the MOS image sensor circuit.

FIGS. 3A and 3B show operation timings of the shutter-vertical line scanning circuit and the shutter-multiplexer circuit.

FIG. 4 is a circuit diagram showing specific configurations of a shutter-vertical line scanning circuit and a shutter-multiplexer circuit constituting a MOS image sensor circuit according to Embodiment 2 of the present invention.

FIG. 5 shows an operation timing of the shutter-vertical line scanning circuit.

FIG. 6 is a circuit diagram showing specific configurations of a shutter-vertical line scanning circuit and a shutter-multiplexer circuit constituting a MOS image sensor circuit according to Embodiment 3 of the present invention.

FIG. 7 shows an operation timing of the shutter-multiplexer circuit.

FIG. 8 is a circuit diagram showing specific configurations of a shutter-vertical line scanning circuit and a shutter-multiplexer circuit constituting a MOS image sensor circuit according to Embodiment 4 of the present invention.

FIG. 9 shows an operation timing of the shutter-multiplexer circuit.

FIG. 10 is a block diagram showing a MOS image sensor circuit according to Embodiment 5 of the present invention.

FIG. 11 is a circuit diagram showing specific configurations of a shutter-vertical line scanning circuit and a shutter-multiplexer circuit constituting the MOS image sensor circuit.

FIG. 12 shows an operation timing of the shutter-multiplexer circuit.

FIG. 13 is a circuit diagram showing specific configurations of a shutter-vertical line scanning circuit and a shutter-multiplexer circuit constituting a MOS image sensor circuit according to Embodiment 6 of the present invention.

FIG. 14 shows an operation timing of the shutter-multiplexer circuit.

FIG. 15 is a block circuit diagram showing an imaging system according to Embodiment 7 of the present invention.

FIG. 16 is a block circuit diagram showing a MOS image sensor circuit in a conventional example.

FIG. 17 shows an operation timing of the MOS image sensor circuit.

FIG. 18 is a circuit diagram showing a specific configuration of a shift register constituting the MOS image sensor circuit.

FIG. 19 shows an operation timing of the shift register.

FIG. 20 is a circuit diagram showing specific configurations of the shift registers and a multiplexer circuit constituting the MOS image sensor circuit.

FIGS. 21A and 21B show operation timings of the shift registers and the multiplexer circuit.

FIG. 22 is a block circuit diagram showing a MOS image sensor circuit in another conventional example.

FIG. 23 shows an operation timing of the MOS image sensor circuit.

FIG. 24 is a circuit diagram showing specific configurations of shift registers and a multiplexer circuit constituting the MOS image sensor circuit.

FIGS. 25A and 25B show operation timings of the shift registers and the multiplexer circuit.

### DETAILED DESCRIPTION OF THE INVENTION

In accordance with the configuration of the XY address type solid-state imaging device of the present invention, it becomes possible to use one vertical scanning circuit for both scanning for reading out an accumulated charge in a pixel and scanning for clearing the accumulated charge in the pixel, and to use one multiplexer circuit for outputting both an accumulated charge readout signal and an accumulated charge clearing signal, thus allowing a reduction of a chip area and an improvement in an operation yield.

The solid-state imaging device according to the present invention can include a scanning purpose selecting circuit that is provided so as to correspond to each of scanning stages of the vertical scanning circuit and outputs selectively the signal outputted from the vertical scanning circuit as either the scanning signal for reading out the accumulated charge or the scanning signal for clearing the accumulated charge based on a selection of one of a scanning for reading out the accumulated charge in the pixel and a scanning for clearing the accumulated charge in the pixel. A scanning signal time division circuit is provided so as to correspond to each of the scanning stages of the vertical scanning circuit and outputs the accumulated charge readout signal and the accumulated charge clearing signal of the pixel to the multiplexer circuit by time division based on the scanning signal for reading out the accumulated charge and the scanning signal for clearing the accumulated charge outputted from the scanning purpose selecting circuit.

In this configuration, it is preferable that the scanning purpose selecting circuit starts operating by an input of a scanning start signal of the vertical scanning circuit. This makes it possible to constitute the scanning purpose selecting circuit without providing a new control pulse.

Also, it is preferable that the scanning purpose selecting circuit is scanned sequentially by using as a starting pulse the scanning signal for reading out the accumulated charge or the scanning signal for clearing the accumulated charge outputted from a scanning stage immediately before the scanning stage corresponding to this scanning purpose selecting circuit. This makes it possible to constitute the scanning purpose selecting circuit without providing a new control pulse.

Further, it is preferable that the scanning purpose selecting circuit is scanned sequentially by using as a stopping pulse the scanning signal for reading out the accumulated charge or the scanning signal for clearing the accumulated charge outputted from a scanning stage immediately after the scanning stage corresponding to this scanning purpose selecting circuit. This makes it possible to constitute the scanning purpose selecting circuit without providing a new control pulse.

Also, preferably, the scanning purpose selecting circuit corresponding to a scanning stage after a first scanning stage of the vertical scanning circuit incorporates a bootstrap circuit for suppressing attenuation of the accumulated charge readout signal and the accumulated charge clearing signal, and the accumulated charge readout signal or the accumulated charge clearing signal at a scanning stage immediately before the scanning stage corresponding to this scanning purpose selecting circuit is used as an input signal to the bootstrap circuit. This makes it possible to transmit an input signal voltage to a pixel portion without attenuating.

Further, preferably, the scanning purpose selecting circuit corresponding to the first scanning stage of the vertical scanning circuit also incorporates the bootstrap circuit, and a signal different from the accumulated charge readout signal or the accumulated charge clearing signal is supplied as the input signal for bootstrap. This suppresses a slight voltage drop at the first stage of the scanning circuit, making it possible to transmit an input signal voltage to a pixel portion without attenuating.

In the solid-state imaging device according to the present invention, the scanning signal time division circuit can be supplied with a row selection signal for driving selectively a pixel in a predetermined row in the plurality of pixels that is to be supplied to the multiplexer circuit, and a time division operation of the scanning signal time division circuit can be controlled based on the row selection signal. This makes it possible to use one multiplexer circuit for outputting both the accumulated charge readout signal and the accumulated charge clearing signal without providing a new control pulse.

Moreover, a noise canceller circuit for removing a noise of an output signal of the pixels can be provided. A sample hold pulse of the noise canceller circuit can be inputted to the scanning signal time division circuit, and a time division operation of the scanning signal time division circuit can be controlled based on the sample hold pulse. This makes it possible to use one multiplexer circuit for outputting both the accumulated charge readout signal and the accumulated charge clearing signal without providing a new control pulse.

Furthermore, each of the plurality of pixels that are arranged two-dimensionally can include four transistors consisting of a transfer transistor, a reset transistor, an amplification transistor and a row selection transistor. Three signals of a reset signal, a transfer signal and a row selection signal can be outputted from the multiplexer circuit in order to read out the accumulated charge in each of the pixels, and the reset signal and the transfer signal can be outputted from the multiplexer circuit in order to clear the accumulated charge in each of the pixels. In this way, even in the pixel constituted by four transistors, an electronic shutter operation can be performed simply by providing one multiplexer circuit.

Alternatively, each of the plurality of pixels that are arranged two-dimensionally can include three transistors consisting of a transfer transistor, a reset transistor and an amplification transistor, and a reset signal and a transfer signal can be outputted from the multiplexer circuit in order to read out the accumulated charge and clear the accumulated charge in each of the pixels. In this way, even in the pixel constituted by three transistors, an electronic shutter operation can be performed simply by providing one multiplexer circuit.

In addition, all of the circuits can be constituted by an N-type MOS transistor and an N-type MOS capacitor. This shortens the production process, thus achieving a cost reduction.

It is possible to constitute a camera or an imaging system including the XY address type solid-state imaging device having any of the configurations described above.

The following is a more specific description of embodiments of the present invention, with reference to the accompanying drawings.

### Embodiment 1

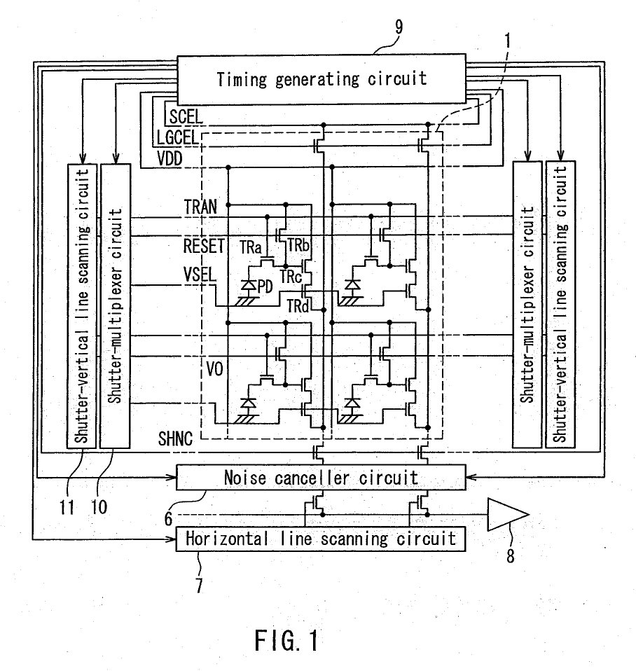

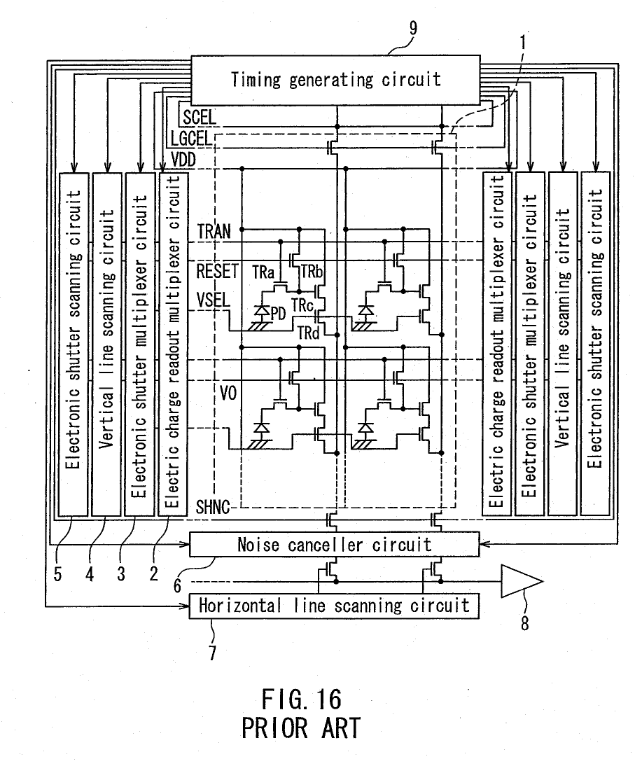

FIG. 1 is a block diagram showing a MOS image sensor circuit according to Embodiment 1 of the present invention. This circuit has a basic configuration similar to the circuit in the conventional example illustrated in FIG. 16, and is different from the circuit of FIG. 16 in that the electric charge readout multiplexer circuit 2 and the electronic shutter multiplexer circuit 3 are combined to provide a shutter-multiplexer circuit 10, and the vertical line scanning circuit 4 and the electronic shutter scanning circuit 5 are combined to provide a shutter-vertical line scanning circuit 11.

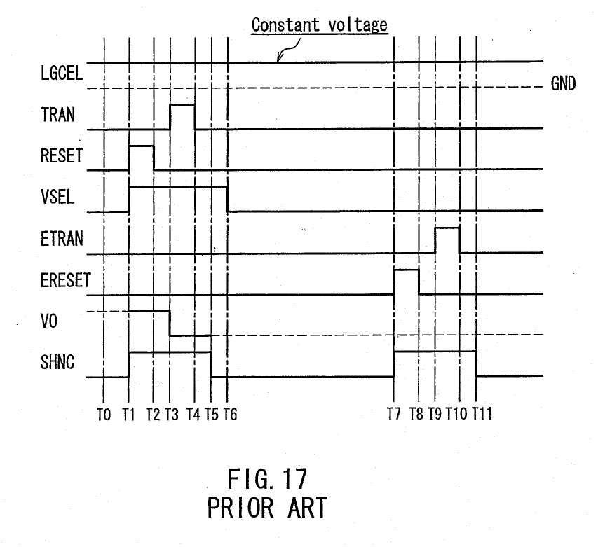

In other words, the present embodiment is characterized by using one vertical scanning circuit for outputting both a scanning signal for reading out an accumulated charge and a scanning signal for clearing the accumulated charge, and using one multiplexer circuit for outputting both an accumulated charge readout signal and an accumulated charge clearing signal. This makes it possible to reduce a chip area and suppress a reduction of an operation yield in the case of providing two vertical scanning circuits and two multiplexer circuits. The other configuration is similar to that of the circuit shown in FIG. 16. Common elements are given the same reference numerals, and the description thereof will not be repeated. The entire operation of this circuit also follows the timing shown in FIG. 17 in a similar manner, and thus, the illustration and description thereof will not be repeated here.

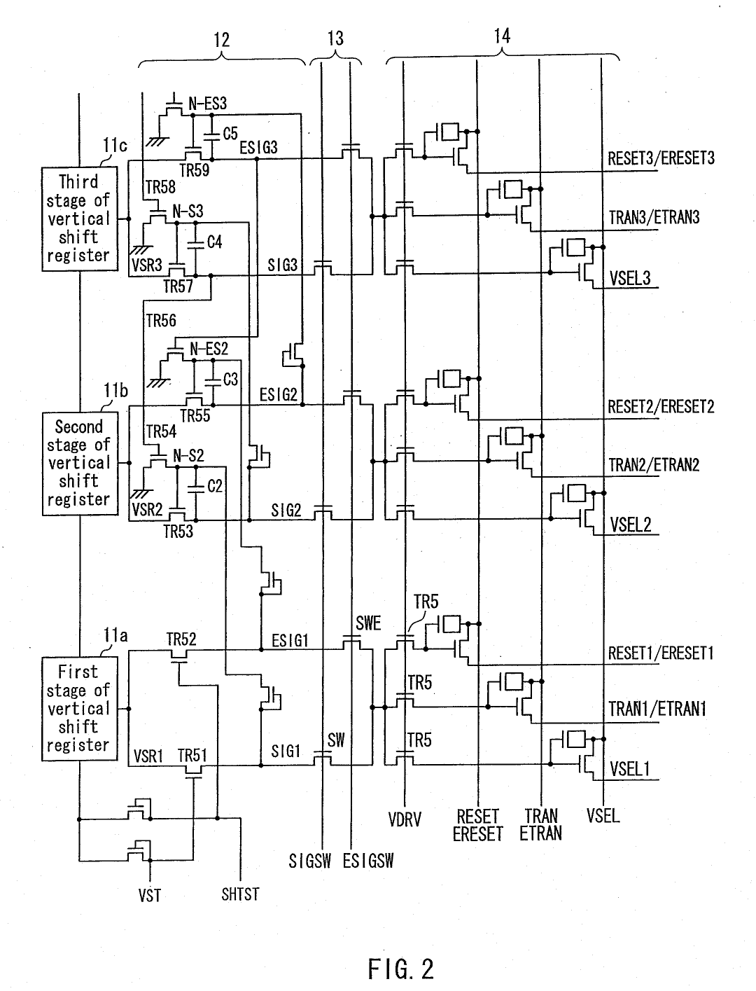

FIG. 2 shows specific circuit configurations including the shutter-multiplexer circuit 10 and the shutter-vertical line scanning circuit 11 constituting the MOS image sensor circuit of FIG. 1.

FIG. 2 shows vertical shift registers 11a to 11c at first to third stages constituting the shutter-vertical line scanning circuit 11. In the circuit of FIG. 2, the shutter-vertical line scanning circuit 11 is constituted by the vertical shift registers 11a to 11c and a scanning purpose selecting circuit 12. Also, the shutter-multiplexer circuit 10 is constituted by a scanning signal time division circuit 13 and a multiplexer circuit 14.

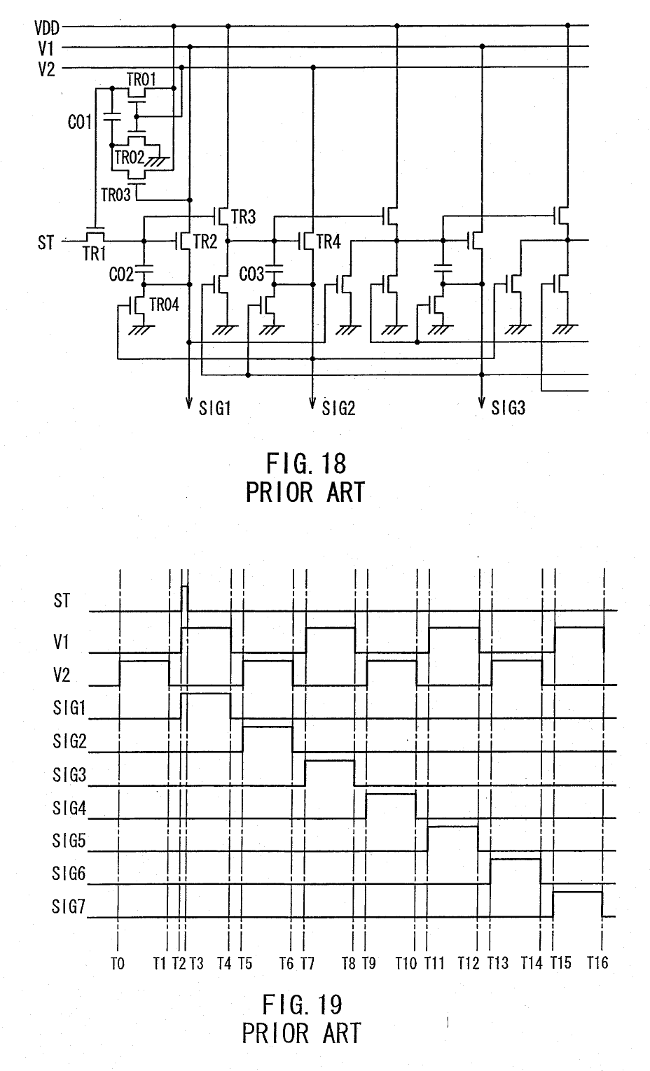

Output signals from the vertical shift registers 11a to 11c at the respective stages are supplied to the multiplexer circuit 14 via the scanning purpose selecting circuit 12 and the scanning signal time division circuit 13. The scanning purpose selecting circuit 12 is constituted so that one vertical shift register can be used for both scanning for reading out an accumulated charge in a pixel and scanning for clearing the accumulated charge in the pixel. The vertical shift registers 11a to 11c can have a configuration similar to the circuits in the conventional example illustrated in FIG. 18.

The scanning purpose selecting circuit 12 is constituted by transistors TR51, TR53 and TR57 that operate at the time of reading out an accumulated charge in a pixel and transistors TR52, TR55 and TR59 that operate at the time of clearing the accumulated charge, etc. for performing a selective operation corresponding to the vertical shift registers 11a to 11c at the respective stages. Also, the respective stages of the scanning purpose selecting circuit 12 corresponding to the vertical shift registers 11a to 11c after the first stage are provided with bootstrap capacitors C2, C3, C4 and C5, etc.

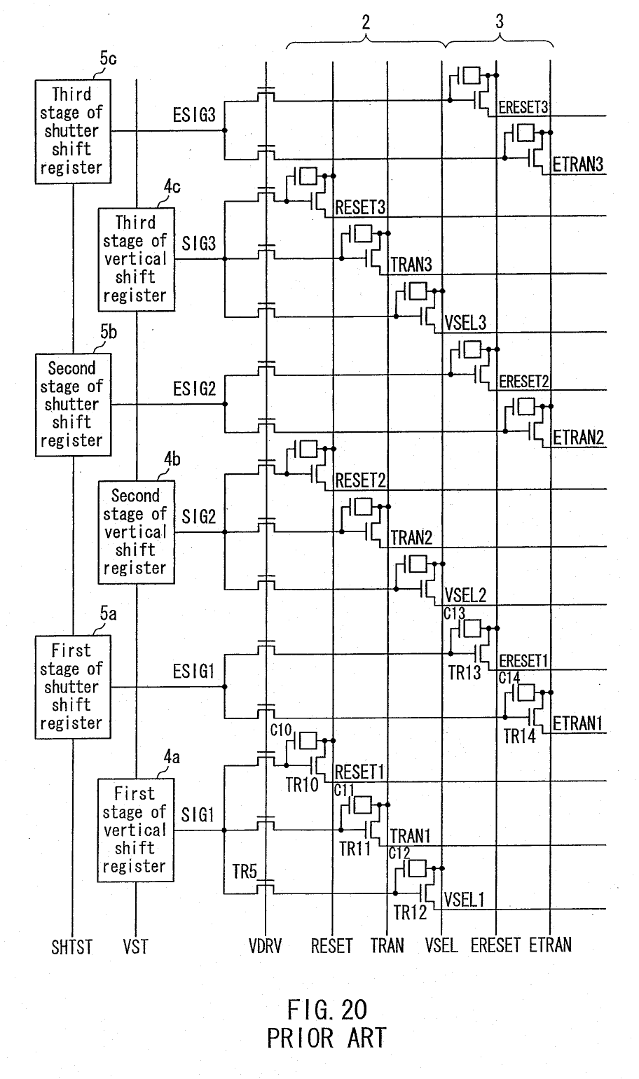

The multiplexer circuit 14 has a configuration similar to the electric charge readout multiplexer circuit 2 in the conventional example illustrated in FIG. 20. The scanning signal time division circuit 13 is formed of a switch SW and a switch SWE interposed between the scanning purpose selecting circuit 12 and the multiplexer circuit 14. Outputs of the vertical shift registers 11a to 11c at the respective stages are switched by the scanning purpose selecting circuit 12 and then transmitted to corresponding stages of the multiplexer circuit 14 by time division by the scanning signal time division circuit 13. Thus, in this configuration, the scanning signal time division circuit 13 allows the multiplexer circuit 14 to be used for both outputting the accumulated charge readout signal and the accumulated charge clearing signal.

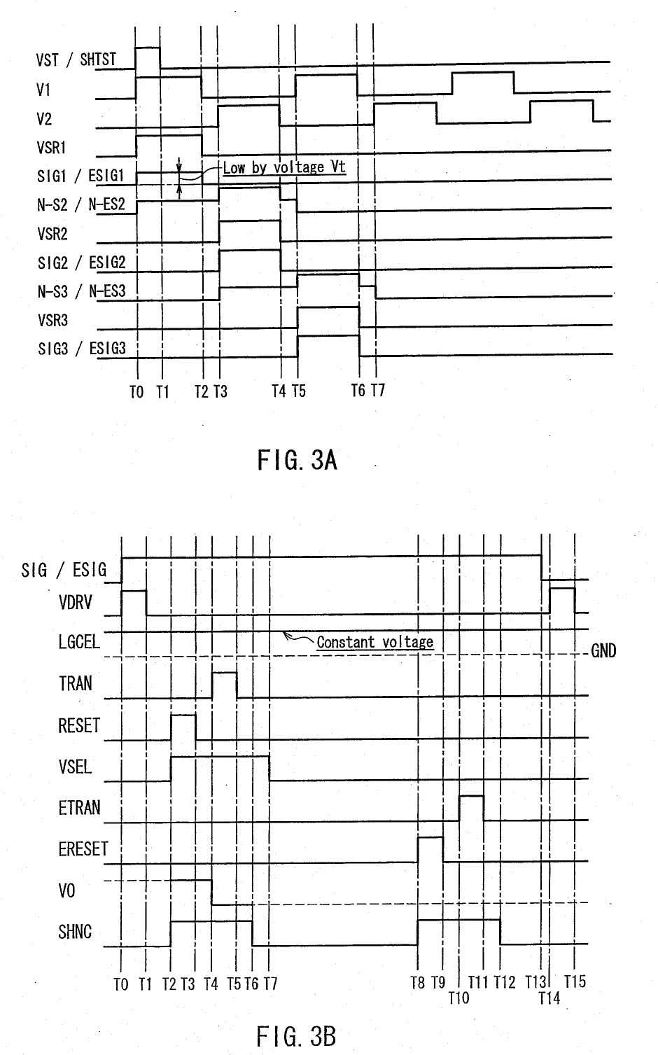

Referring to FIGS. 3A and 3B, the operation timings of the circuits of FIG. 2 will be described. FIG. 3A shows the operation timings of the vertical shift registers 11a to 11c, and FIG. 3B shows the operation timings of the multiplexer circuit 14 and the scanning signal time division circuit 13.

Incidentally, although the same time signs are provided in FIGS. 3A and 3B, they do not necessarily mean the same time. The period of a SIG/ESIG pulse shown in FIG. 3B corresponds to a period of a SIG1/ESIG1 pulse in the FIG. 3A, for example.

First, the operations of the vertical shift registers 11a to 11c and the canning purpose selecting circuit 12 at the time of reading out an accumulated charge in a pixel will be described with reference to FIG. 3A. When an accumulated charge readout start pulse VST and a first scan pulse V1 are turned ON at time T0, a VSR1 pulse is outputted to the first stage of the scanning purpose selecting circuit 12 from the vertical shift register 11a at the first stage to which the start pulse VST has been inputted. At the same time, in order to supply the start pulse VST to the transistor TR51 at the first stage of the scanning purpose selecting circuit 12, the VSR1 pulse is attenuated by a threshold (Vt) of the transistor TR51 and is transmitted as a SIG1 pulse to the switch SW of the scanning signal time division circuit 13. This SIG1 pulse also is inputted to an electrode N-S2 of the bootstrap capacitor C2 at the second stage of the scanning purpose selecting circuit 12, thus starting charging the bootstrap capacitor C2.

When the start pulse VST is turned OFF at time T1, the first scan pulse V1 is turned OFF at time T2 and a second scan pulse V2 is turned ON at time T3, a VSR2 pulse is inputted from the vertical shift register 11b at the second stage to the second stage of the scanning purpose selecting circuit 12. At this time, since the electrode N-S2 of the bootstrap capacitor C2 is charged, the transistor TR53 is turned ON, and the electrode N-S2 of the bootstrap capacitor C2 further is boosted. Accordingly, the VSR2 pulse is transmitted to the switch SW of the scanning signal time division circuit 13 as a SIG2 pulse without being affected by a threshold of the transistor TR53. This SIG2 pulse also is inputted to an electrode N-S3 of the bootstrap capacitor C4 at the third stage of the scanning purpose selecting circuit 12, thus starting charging the bootstrap capacitor C4.

When the second scan pulse V2 is turned OFF at time T4 and the first scan pulse V1 is turned ON at time T5, a VSR3 pulse is inputted from the vertical shift register 11c at the third stage to the third stage of the scanning purpose selecting circuit 12. At this time, since the electrode N-S3 of the bootstrap capacitor C4 is charged, the transistor TR57 is turned ON, and the electrode N-S3 of the bootstrap capacitor C4 further is boosted. Accordingly, the VSR3 pulse is transmitted to the switch SW of the scanning signal time division circuit 13 as a SIG3 pulse without being affected by a threshold of the transistor TR57. At this time, the SIG3 pulse is inputted to the transistor TR54 at the second stage of the scanning purpose selecting circuit 12, whereby the electric potential of the electrode N-S2 of the bootstrap capacitor C2 at the second stage of the scanning purpose selecting circuit 12 is reset to GND. Thus, the SIG3 pulse is used as a stopping pulse for the operation of the second stage of the scanning purpose selecting circuit 12.

Hereafter, similar operations are repeated, whereby the individual VSR pulses are transmitted as the SIG pulses to the switches SW of the scanning signal time division circuit 13 sequentially with the scanning without attenuating.

The operations of the vertical shift registers 11a to 11c and the scanning purpose selecting circuit 12 at the time of clearing an accumulated charge in a pixel are similar to the above. In FIG. 3A, the operation starts when an accumulated charge clearing start pulse SHTST and a first scan pulse V1 are turned ON at time T0, and a VSR1 pulse is inputted to the first stage of the scanning purpose selecting circuit 12 from the vertical shift register 11a at the first stage to which the start pulse SHTST has been inputted. At the same time, since the start pulse SHTST is supplied to the transistor TR52 at the first stage of the scanning purpose selecting circuit 12, the VSR1 pulse is attenuated by a threshold of the transistor TR52 and is transmitted as an ESIG1 pulse to the switch SWE of the scanning signal time division circuit 13. This ESIG1 pulse also is inputted to an electrode N-ES2 of the bootstrap capacitor C3 at the second stage of the scanning purpose selecting circuit 12, thus starting the charging of the bootstrap capacitor C3.

When the start pulse SHTST is turned OFF at time T1, the first scan pulse V1 is turned OFF at time T2 and a second scan pulse V2 is turned ON at time T3, a VSR2 pulse is inputted from the vertical shift register 11b at the second stage to the second stage of the scanning purpose selecting circuit 12. At this time, since the electrode N-ES2 of the bootstrap capacitor C3 is charged, the transistor TR55 is turned ON, and the electrode N-ES2 of the bootstrap capacitor C3 further is boosted. Accordingly, the VSR2 pulse is transmitted to the switch SWE of the scanning signal time division circuit 13 as an ESIG2 pulse without being affected by a threshold of the transistor TR55. This ESIG2 pulse also is inputted to an electrode N-ES3 of the bootstrap capacitor C5 at the third stage of the scanning purpose selecting circuit 12, thus starting charging the bootstrap capacitor C5.

When the second scan pulse V2 is turned OFF at time T4 and the first scan pulse V1 is turned ON at time T5, a VSR3 pulse is inputted from the vertical shift register 11c at the third stage to the third stage of the scanning purpose selecting circuit 12. At this time, since the electrode N-ES3 of the bootstrap capacitor C5 is charged, the transistor TR59 is turned ON, and the electrode N-ES3 of the bootstrap capacitor C5 further is boosted. Accordingly, the VSR3 pulse is transmitted to the switch SWE of the scanning signal time division circuit 13 as an ESIG3 pulse without being affected by a threshold of the transistor TR59. At this time, the ESIG3 pulse is inputted to the transistor TR56 at the second stage of the scanning purpose selecting circuit 12, whereby the electric potential of the electrode N-ES2 of the bootstrap capacitor C3 at the second stage of the scanning purpose selecting circuit 12 is reset to GND.

Hereafter, similar operations are repeated, whereby the individual VSR pulses are transmitted as the ESIG pulses to the switches SWE of the scanning signal time division circuit 13 sequentially with the scanning without attenuating.

As described above, whether output pulses of the vertical shift registers 11a to 11c are supplied for generating the accumulated charge readout signal or supplied for generating the accumulated charge clearing signal is selected by the scanning purpose selecting circuit 12, and the output pulses are transmitted to the switch SW or the switch SWE of the scanning signal time division circuit 13.

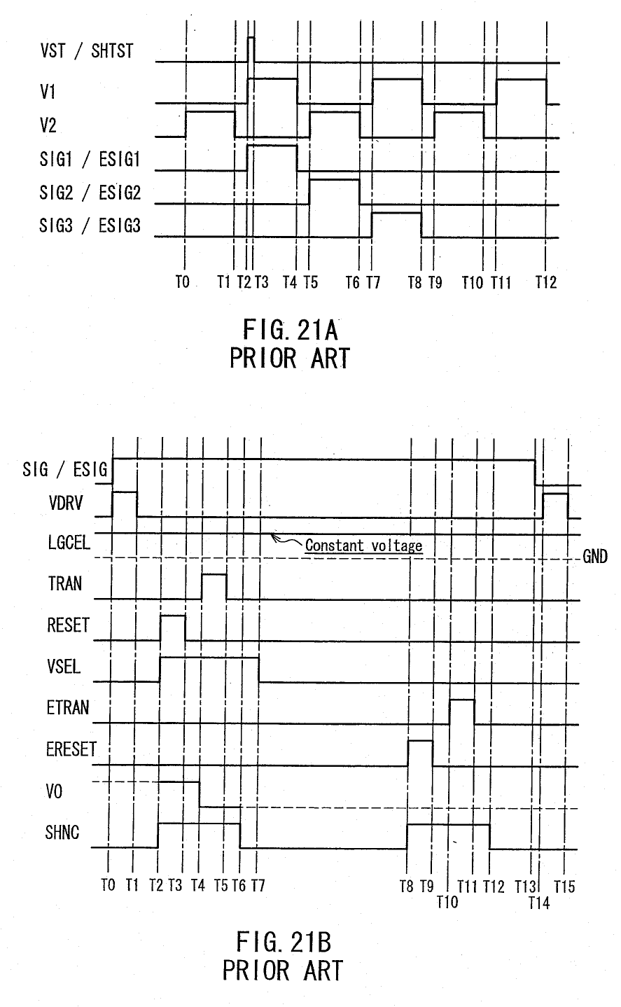

The operation timing of the multiplexer circuit 14 shown in FIG. 3B is substantially similar to those of the electric charge readout multiplexer circuit 2 and the electronic shutter multiplexer circuit 3 described with reference to FIGS. 20 and 21B. However, because of the scanning signal time division circuit 13, the operation differs as described below.

In the operation shown in FIG. 21B, the accumulated charge readout signal is outputted at times T0 to T7 by the operation of the electric charge readout multiplexer circuit 2, and the accumulated charge clearing signal is outputted at times T8 to T12 by the operation of the electronic shutter multiplexer circuit 3. On the other hand, in the operation shown in FIG. 3B, the multiplexer circuit 14 operates similarly to both of the multiplexer circuits 2 and 3 shown in FIG. 21B, whereby the accumulated charge readout signal and the accumulated charge clearing signal are outputted. Thus, a detailed description of the operation will not be repeated.

The operation of the scanning signal time division circuit 13 for allowing the multiplexer circuit 14 to operate as described above will be described with reference to FIG. 3B.

Based on the scanning signal VSR from the vertical shift registers 11a to 11c, the scanning purpose selecting circuit 12 outputs the accumulated charge readout signal SIG to the switch SW of the scanning signal time division circuit 13 during a period in which a SIGSW pulse is ON, whereas it outputs the accumulated charge clearing signal ESIG to the switch SWE of the scanning signal time division circuit 13 during a period in which an ESIGSW pulse is ON.

At times T2 to T7 during the period in which a SIG pulse is ON, three signals of a reset signal RESET, a transfer signal TRAN and a row selection signal VSEL for reading out the accumulated charge in the pixel are outputted from the multiplexer circuit 14. At times T8 to T11 during the period in which an ESIG pulse is ON, a reset signal ERESET and a transfer signal ETRAN for clearing the accumulated charge in the pixel are outputted from the multiplexer circuit 14.

In accordance with the present embodiment, by providing the simple scanning purpose selecting circuit 12 and the simple scanning signal time division circuit 13, it is possible to perform a vertical line scanning and an electronic shutter scanning with one shutter-vertical line scanning circuit 11 and to output an accumulated charge readout signal and an accumulated charge clearing signal with one shutter-multiplexer circuit 10, thus reducing a chip area and suppressing a reduction of an operation yield caused by providing two shift registers and two multiplexer circuits.

### Embodiment 2

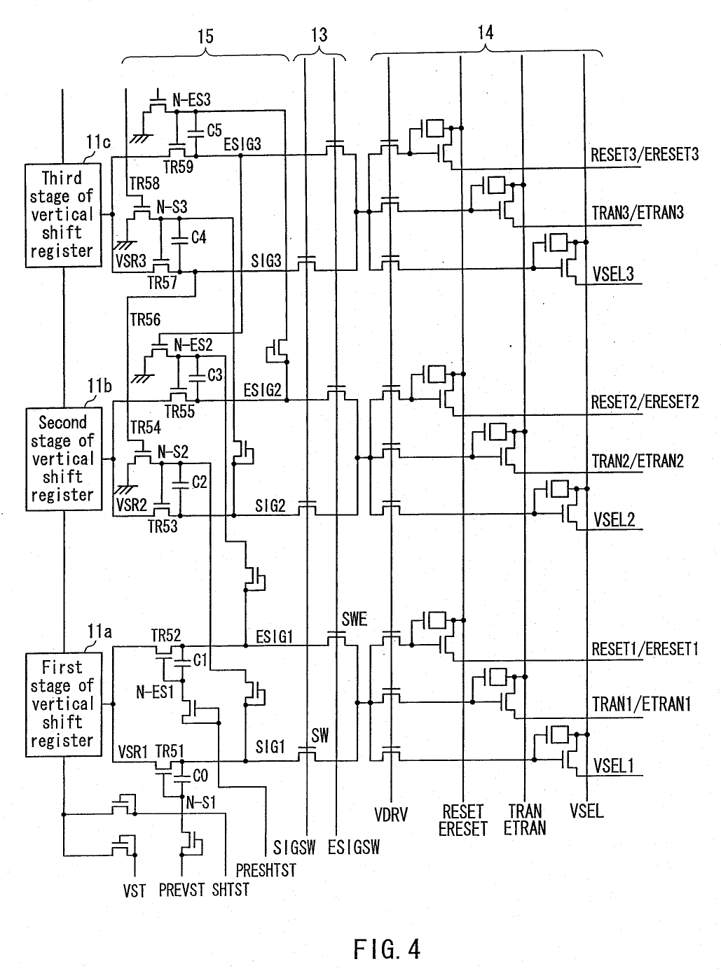

A MOS image sensor circuit according to Embodiment 2 of the present invention has an overall configuration similar to that shown in FIG. 1, and is different from the circuit of Embodiment 1 shown in FIG. 2 in the configuration of the scanning purpose selecting circuit 12. FIG. 4 shows specific configurations including a scanning purpose selecting circuit 15, a scanning signal time division circuit 13 and a multiplexer circuit 14 in the present embodiment.

The scanning purpose selecting circuit 15 of the present embodiment is obtained by improving the fact that, in the scanning purpose selecting circuit 12 in Embodiment 1, the VSR1 pulse inputted to the first stage is attenuated by the threshold of the transistor TR51 and appears as the SIG1. The scanning purpose selecting circuit 15 has a basic configuration similar to the scanning purpose selecting circuit 12 shown in FIG. 2 but is different therefrom in the configuration at the first stage. That is, bootstrap capacitors C0 and C1 are provided at the first stage, and start pulses for bootstrap PREVST and PRESHTST are inputted so as to form a boosting circuit, thereby suppressing the attenuation of the voltage appearing as the SIG1 and ESIG1.

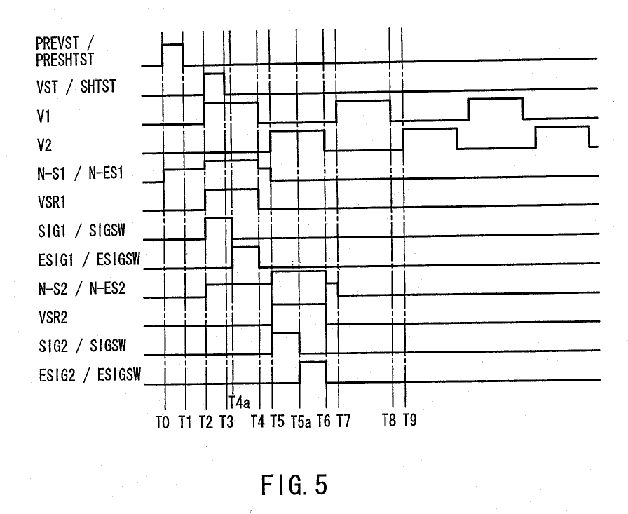

Referring to FIG. 5, the operation timing will be described. First, the operations of the vertical shift registers 11a to 11c and the scanning purpose selecting circuit 15 at the time of reading out an accumulated charge in a pixel will be described. At time T0, the start pulse for bootstrap PREVST is turned ON, and at time T1, PREVST is turned OFF. The pulse PREVST is supplied to an electrode N-S1 of the bootstrap capacitor C0 at the first stage of the scanning purpose selecting circuit 15, thus starting charging of the capacitor CO. When the accumulated charge readout start pulse VST and the first scan pulse V1 are turned ON at time T2, a VSR1 pulse is inputted from the vertical shift register 11a at the first stage to the first stage of the scanning purpose selecting circuit 15. At this time, since the electrode N-S1 of the bootstrap capacitor C0 is charged, the transistor TR51 is turned ON, and the electrode N-S1 of the bootstrap capacitor C0 further is boosted. Accordingly, the VSR1 pulse appears as a SIG1 without being affected by a threshold of the transistor TR51. This SIG1 also is inputted to an electrode N-S2 of a bootstrap capacitor C2 at the second stage of the scanning purpose selecting circuit 15, thus starting charging the capacitor C2.

The start pulse VST is turned OFF at time T3, and the first scan pulse V1 is turned OFF at time T4. When the second scan pulse V2 is turned ON at time T5, a VSR2 pulse is inputted from the vertical shift register 11b at the second stage to the second stage of the scanning purpose selecting circuit 15. At this time, since the electrode N-S2 of the bootstrap capacitor C2 is charged, the transistor TR53 is turned ON, and the electrode N-S2 of the bootstrap capacitor C2 further is boosted. Accordingly, the VSR2 pulse appears as a SIG2 without being affected by a threshold of the transistor TR53.

When the first scan pulse V1 is turned ON at time T7, a VSR3 pulse is inputted from the vertical shift register 11c at the third stage to the third stage of the scanning purpose selecting circuit 15. At this time, since an electrode N-S3 of a bootstrap capacitor C4 is charged, the transistor TR57 is turned ON, and the electrode N-S3 of the bootstrap capacitor C4 further is boosted. Accordingly, the VSR3 pulse appears as a SIG3 without being affected by a threshold of the transistor TR57. At this time, the SIG3 is inputted to the transistor TR54 at the second stage of the scanning purpose selecting circuit 15, whereby the electric potential of the electrode N-S2 of the bootstrap capacitor C2 at the second stage of the scanning purpose selecting circuit 15 is reset to GND.

Hereafter, the same operations are repeated, whereby the VSR pulses appear as the SIG pulses while being scanned sequentially without attenuating.

The operation of the scanning purpose selecting circuit 15 at the time of clearing an accumulated charge in a pixel is similar to the above. In FIG. 5, at time T0, PRESHTST is turned ON, and at time T1, it is turned OFF, thus starting charging of the capacitor C1 through an electrode N-ES1 of the bootstrap capacitor C1 at the first stage of the scanning purpose selecting circuit 15. When an accumulated charge clearing start pulse SHTST and a first scan pulse V1 are turned ON at time T2, a VSR1 pulse is inputted from the vertical shift register 11a at the first stage to the first stage of the scanning purpose selecting circuit 15. At this time, since the electrode N-ES1 of the bootstrap capacitor C1 is charged, the transistor TR52 is turned ON, and the electrode N-ES1 of the bootstrap capacitor C1 further is boosted. Accordingly, the VSR1 pulse appears as an ESIG1 without being affected by a threshold of the transistor TR52 (at time T4a). Hereafter, the same operations are repeated, whereby the VSR pulses appear as the ESIG pulses while being scanned sequentially without attenuating.

As described above, whether output pulses of the vertical shift registers 11a to 11c are supplied for generating the accumulated charge readout signal or supplied for generating the accumulated charge clearing signal is selected by the scanning purpose selecting circuit 15, and the output pulses are transmitted to the switch SW or the switch SWE of the scanning signal time division circuit 13.

Since the operation of the shutter-multiplexer circuit 10 is similar to that described in Embodiment 1, the illustration and description thereof will be omitted here.

In accordance with the present embodiment, by providing the simple scanning purpose selecting circuit 15, it is possible to perform a vertical line scanning and an electronic shutter scanning with one shutter-vertical line scanning circuit 11, thus reducing a chip area and suppressing a reduction of an operation yield caused by providing two shift registers and two multiplexer circuits.

### Embodiment 3

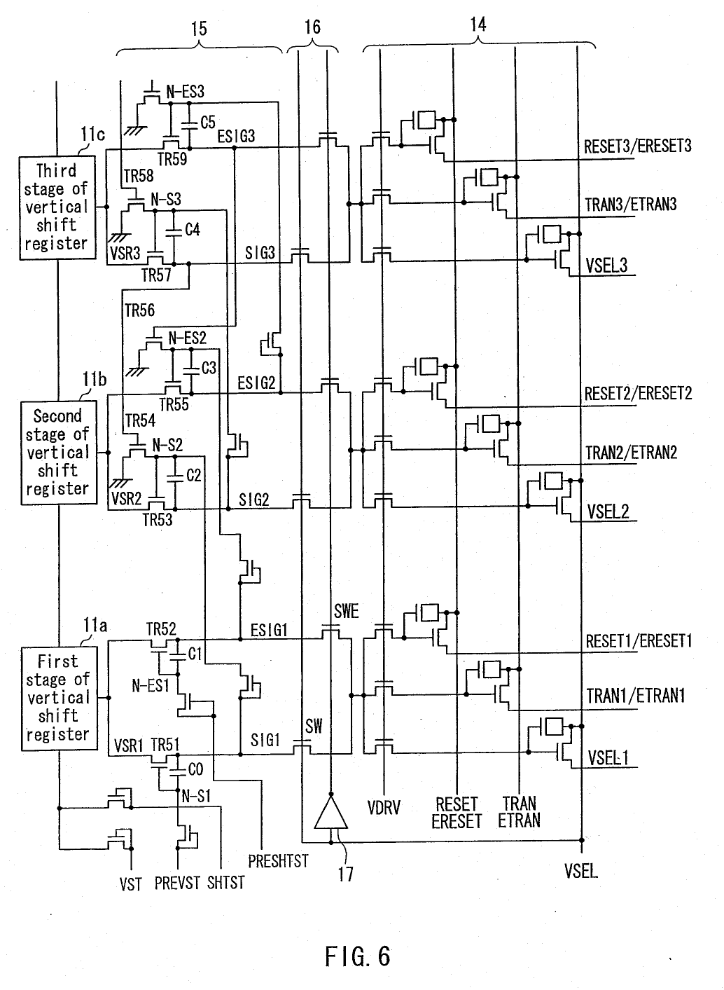

An overall configuration of a MOS image sensor circuit according to Embodiment 3 of the present invention is similar to that in Embodiment 2 shown in FIG. 4. The present embodiment is different from Embodiment 2 in the configuration of the scanning signal time division circuit. FIG. 6 shows specific configurations including vertical shift registers 11a to 11c, a scanning purpose selecting circuit 15, a scanning signal time division circuit 16 and a multiplexer circuit 14 in the present embodiment.

The scanning signal time division circuit 16 in the present embodiment has a configuration obtained by adding an inverter 17 to the scanning signal time division circuit 13 in Embodiment 1. Instead of the SIGSW pulse and the ESIGSW pulse, a VSEL pulse and a signal obtained by inverting the VSEL pulse using the inverter 17 are supplied to the switch SW and the switch SWE.

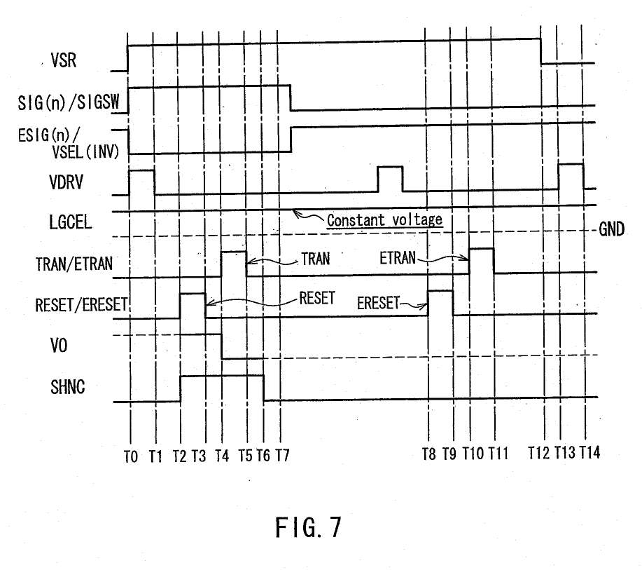

The operation timing of the shutter-vertical line scanning circuit 11 is similar to that of the circuit of FIG. 4 described with reference to FIG. 5, and the illustration and description thereof will be omitted. FIG. 7 shows operation timings of the multiplexer circuit 14 and the scanning signal time division circuit 16. The operation of the multiplexer circuit 14 is similar to that shown in FIG. 3B, and the description thereof will not be repeated.

Referring to FIG. 7, the operation of the scanning signal time division circuit 16 will be described. Based on the scanning signal VSR from the vertical shift registers 11a to 11c, the scanning signal time division circuit 16 outputs the accumulated charge readout signal SIG to the multiplexer circuit 14 during a period in which a row selection signal VSEL pulse is ON, whereas it outputs the accumulated charge clearing signal ESIG to the multiplexer circuit 14 during a period in which the inverted pulse of the VSEL pulse is ON.

At times T2 to T7 during the period in which a SIG pulse is ON, three signals of a reset signal RESET, a transfer signal TRAN and the row selection signal VSEL for reading out the accumulated charge in the pixel are outputted from the multiplexer circuit 14. At times T8 to T11 during the period in which an ESIG pulse is ON, a reset signal ERESET and a transfer signal ETRAN for clearing the accumulated charge in the pixel are outputted from the multiplexer circuit 14.

As described above, with the simple scanning signal time division circuit 16, it is possible to use one shutter-multiplexer circuit 10 to output both the accumulated charge readout signal and the accumulated charge clearing signal, thus reducing a chip area and suppressing a reduction of an operation yield caused by providing two multiplexers.

### Embodiment 4

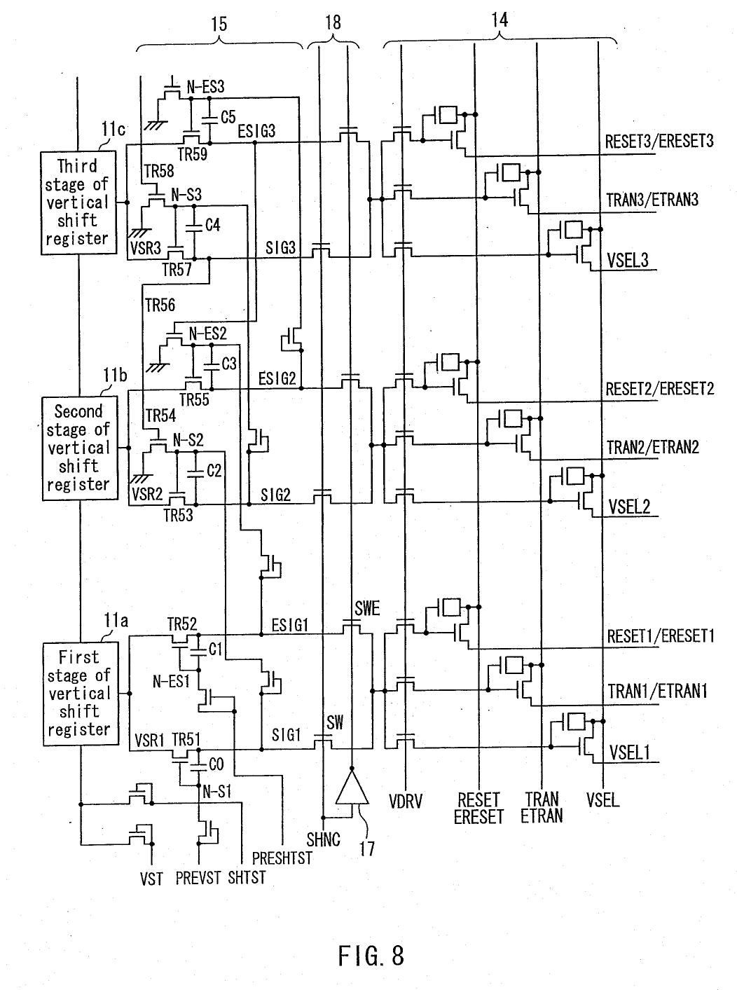

An overall configuration of a MOS image sensor circuit according to Embodiment 4 of the present invention is similar to that in Embodiment 3 shown in FIG. 6. The present embodiment is different from Embodiment 3 in the configuration of the scanning signal time division circuit. FIG. 8 shows specific configurations including vertical shift registers 11a to 11c, a scanning purpose selecting circuit 15, a scanning signal time division circuit 18 and a multiplexer circuit 14 in the present embodiment.

The scanning signal time division circuit 18 in the present embodiment is different from the scanning signal time division circuit 16 in Embodiment 3 in the following respect. That is, instead of the VSEL pulse, a sample hold pulse SHNC of a noise canceller circuit 6 and a signal obtained by inverting the sample hold pulse SHNC using the inverter 17 are supplied to the switch SW and the switch SWE, respectively.

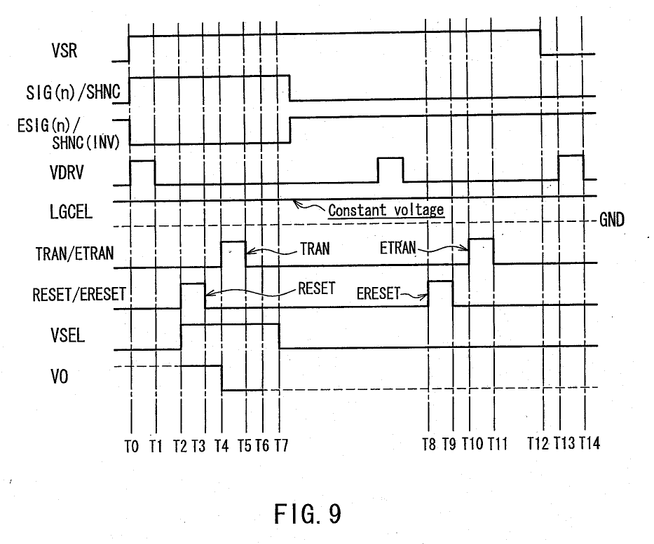

The operation timing of the shutter-vertical line scanning circuit 11 is similar to that of the circuit of FIG. 4 described with reference to FIG. 5, and the illustration and description thereof will be omitted. FIG. 9 shows operation timings of the multiplexer circuit 14 and the scanning signal time division circuit 18. The operation of the multiplexer circuit 14 is similar to that shown in FIG. 3B, and the description thereof will not be repeated.

Referring to FIG. 9, the operation of the scanning signal time division circuit 18 will be described. Based on the scanning signal VSR from the vertical shift registers 11a to 11c, the scanning signal time division circuit 18 outputs the accumulated charge readout signal SIG to the multiplexer circuit 14 during a period in which the sample hold pulse SHNC is ON, whereas it outputs the accumulated charge clearing signal ESIG to the multiplexer circuit 14 during a period in which the inverted pulse of the sample hold pulse SHNC is ON.

At times T2 to T7 during the period in which a SIG pulse is ON, three signals of a reset signal RESET, a transfer signal TRAN and the row selection signal VSEL for reading out the accumulated charge in the pixel are outputted from the multiplexer circuit 14. At times T8 to T11 during the period in which an ESIG pulse is ON, a reset signal ERESET and a transfer signal ETRAN for clearing the accumulated charge in the pixel are outputted from the multiplexer circuit 14.

As described above, with the simple scanning signal time division circuit 18, it is possible to use one shutter-multiplexer circuit 10 to output both the accumulated charge readout signal and the accumulated charge clearing signal, thus reducing a chip area and suppressing a reduction of an operation yield caused by providing two multiplexers.

### Embodiment 5

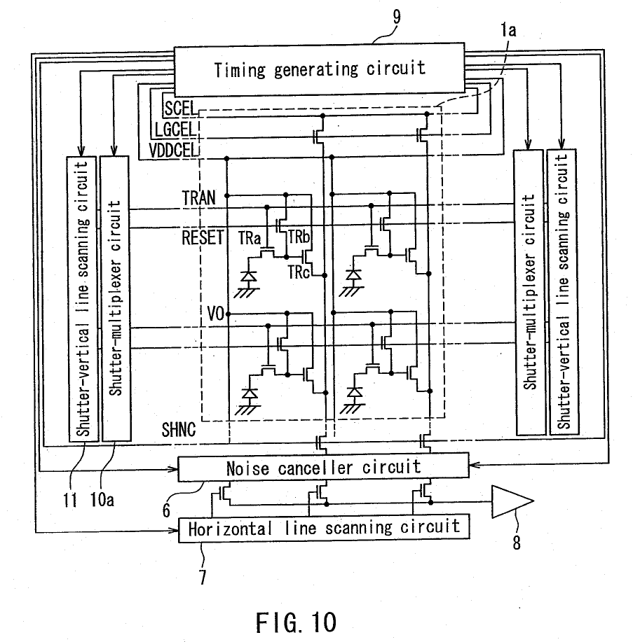

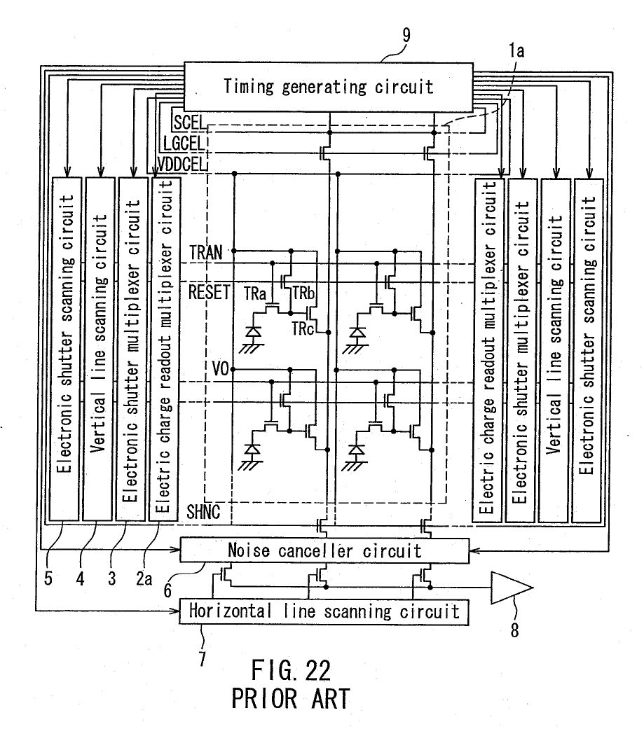

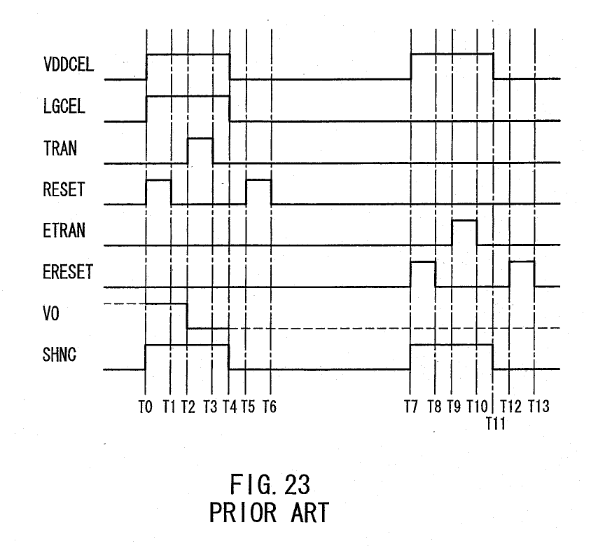

FIG. 10 is a block diagram showing a MOS image sensor circuit according to Embodiment 5 of the present invention. This circuit is obtained by applying a configuration similar to the circuit in Embodiment 2 illustrated in FIG. 4 to the configuration in the conventional example illustrated in FIG. 22, that is, in the case of using no row selection signal VSEL. Thus, the electric charge readout multiplexer circuit 2a and the electronic shutter multiplexer circuit 3 in the configuration in FIG. 22 are combined to provide a shutter-multiplexer circuit 10a and the vertical line scanning circuit 4 and the electronic shutter scanning circuit 5 are replaced by a shutter-vertical line scanning circuit 11. The other basic configuration is similar to that of the circuit illustrated in FIG. 22 and driven by the operation timing as illustrated in FIG. 23, and thus, the illustration and description thereof will not be repeated here.

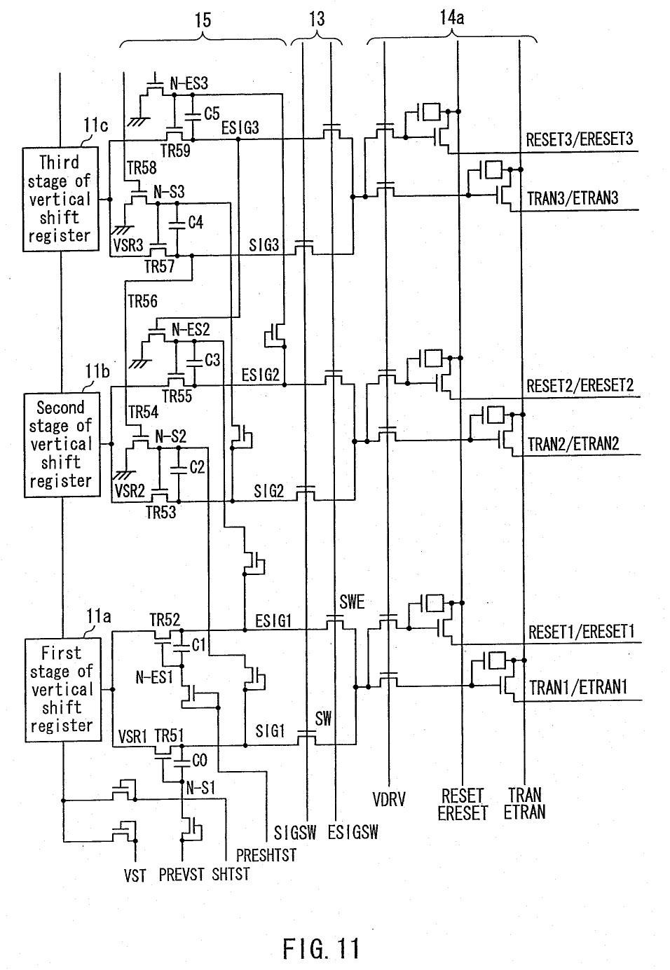

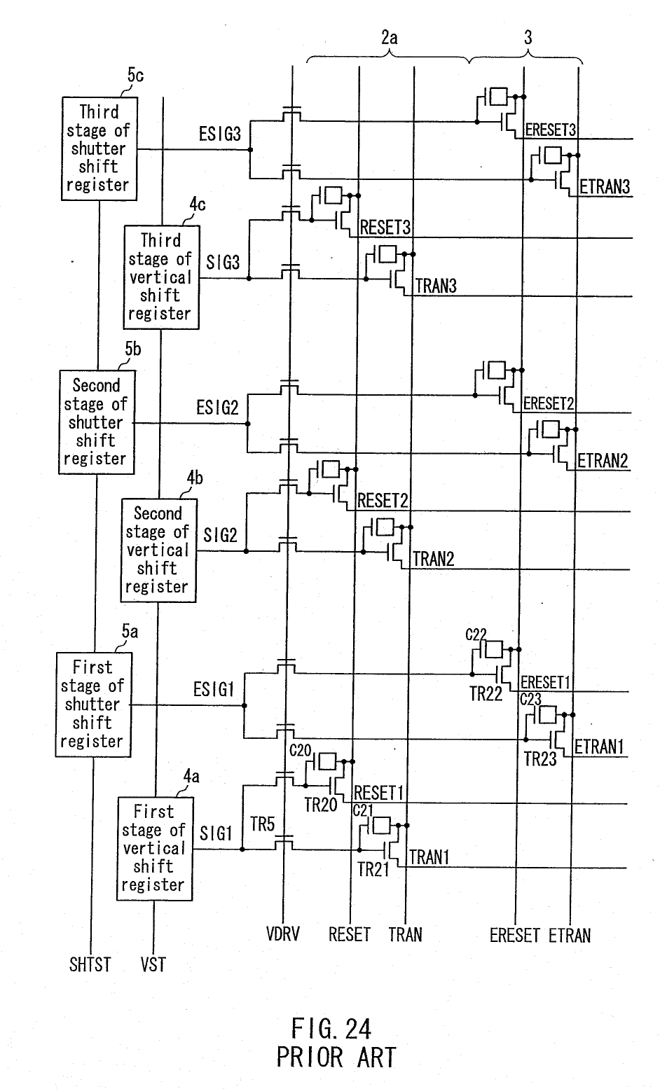

FIG. 11 shows specific circuit configurations including the shutter-multiplexer circuit 10a and the shutter-vertical line scanning circuit 11 constituting the MOS image sensor circuit of FIG. 10. The configuration of the circuit of FIG. 11 basically is similar to that of Embodiment 2 shown in FIG. 4 but is different therefrom in a multiplexer circuit 14a. The multiplexer circuit 14a has a configuration corresponding to the electric charge readout multiplexer circuit 2a in the conventional example shown in FIG. 24.

The timing of the shift register operation of the circuit of FIG. 11 is similar to the case of Embodiment 2 described with reference to FIG. 5, and the illustration and description thereof will not be repeated here.

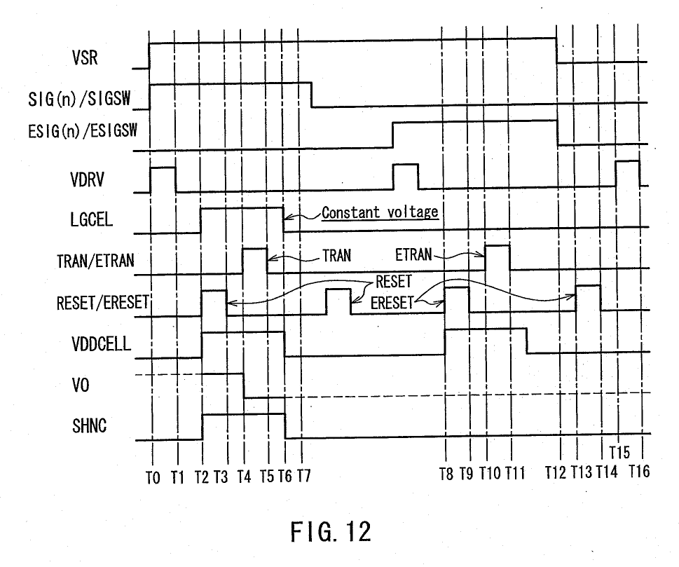

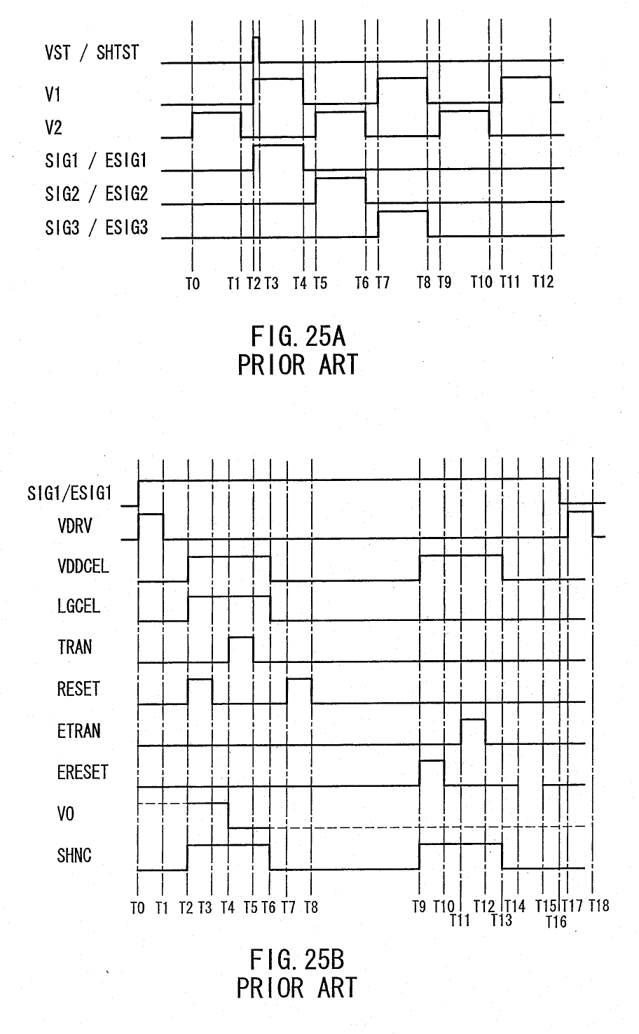

FIG. 12 shows operation timings of the multiplexer circuit 14a and the scanning signal time division circuit 13. The operation timing of the multiplexer circuit 14a is substantially similar to the operations of the electric charge readout multiplexer circuit 2a and the electronic shutter multiplexer circuit 3 described with reference to FIG. 25B. Further, by the operation of the scanning signal time division circuit 13, one multiplexer circuit 14a outputs the accumulated charge readout signal and the accumulated charge clearing signal similarly to Embodiment 2. Thus, a detailed description of the operation will not be repeated.

The operation of the scanning signal time division circuit 13 for allowing the multiplexer circuit 14a to operate as described above is similar to the operation in the case of Embodiment 1 described with reference to FIG. 3B.

As described above, by providing the simple scanning purpose selecting circuit 15 and the simple scanning signal time division circuit 13, it is possible to perform a vertical line scanning and an electronic shutter scanning with one shutter-vertical line scanning circuit 11 and to output an accumulated charge readout signal and an accumulated charge clearing signal with one shutter-multiplexer circuit 10a, thus reducing a chip area and suppressing a reduction of an operation yield caused by providing two shift registers and two multiplexer circuits.

### Embodiment 6

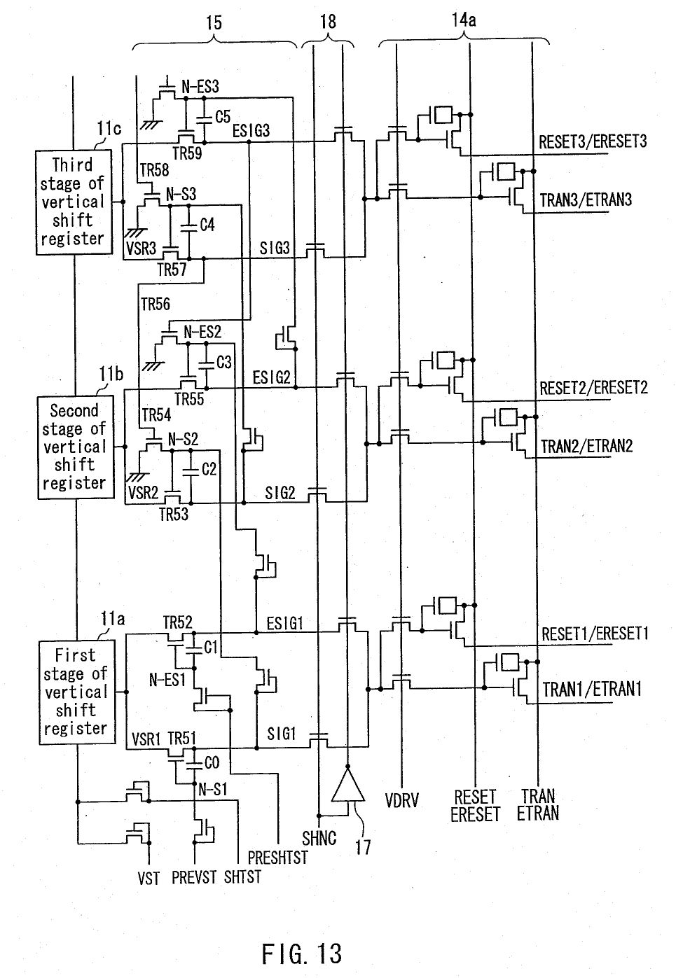

An overall configuration of a MOS image sensor circuit according to Embodiment 6 of the present invention is similar to that in Embodiment 5 shown in FIGS. 10 and 11. The present embodiment is different from Embodiment 5 in the configuration of the scanning signal time division circuit and constituted similarly to the scanning signal time division circuit 18 in Embodiment 4. FIG. 13 shows specific configurations including vertical shift registers 11a to 11c, a scanning purpose selecting circuit 15, a scanning signal time division circuit 18 and a multiplexer circuit 14a in the present embodiment.

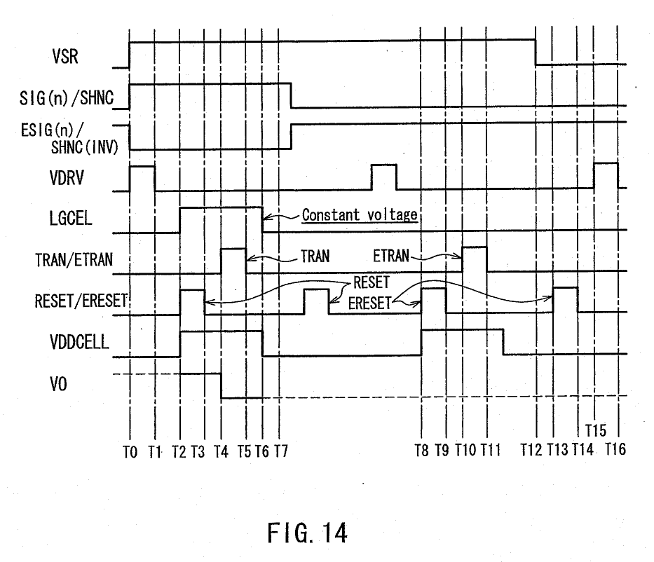

The operation timing of the shutter-vertical line scanning circuit 11 is similar to that of the circuit of FIG. 4 described with reference to FIG. 5, and the illustration and description thereof will be omitted. FIG. 14 shows operation timings of the multiplexer circuit 14a and the scanning signal time division circuit 18. The operation of the multiplexer circuit 14a is similar to that shown in FIG. 3B, and the description thereof will not be repeated. Also, the operation of the scanning signal time division circuit 18 is similar to that of the scanning signal time division circuit 18 shown in FIG. 8 in Embodiment 4 described with reference to FIG. 9, and the description thereof will not be repeated.

As described above, by providing the simple scanning purpose selecting circuit 15 and the simple scanning signal time division circuit 18, it is possible to perform a vertical line scanning and an electronic shutter scanning with one shutter-vertical line scanning circuit 11 and to output an accumulated charge readout signal and an accumulated charge clearing signal with one shutter-multiplexer circuit 10a, thus reducing a chip area and suppressing a reduction of an operation yield caused by providing two shift registers and two multiplexer circuits.

The embodiments described above have been directed to an example in which both of the vertical scanning circuit and the multiplexer circuit are constituted respectively as one combined circuit and used for both reading out an accumulated charge and clearing an accumulated charge (an electronic shutter operation). However, it also may be possible for only one of the vertical scanning circuit and the multiplexer circuit to have a combined configuration. For example, one circuit may be used for both a vertical line scanning and an electronic shutter scanning as the vertical scanning circuit, and an electric charge readout multiplexer circuit and an electronic shutter multiplexer circuit may be used individually as the multiplexer circuit. Alternatively, a vertical line scanning circuit and an electronic shutter scanning circuit may be used individually as the vertical scanning circuit, and one circuit may be used for both an electric charge readout multiplexer and an electronic shutter multiplexer as the multiplexer circuit.

### Embodiment 7

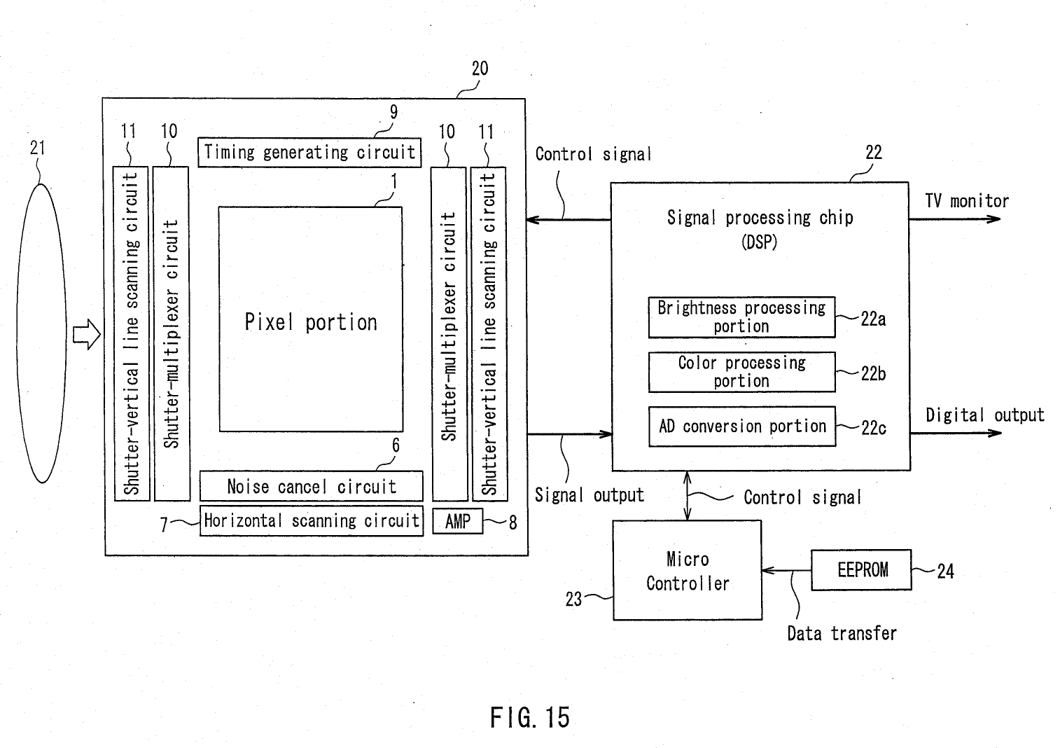

An imaging system according to Embodiment 7 of the present invention will be described with reference to a block circuit diagram shown in FIG. 15.

This imaging system is constituted using an XY address type solid-state imaging device 20 having a configuration described in any of the above embodiments. An imaging lens 21 allows an optical image to be incident on a pixel portion 1 of the solid-state imaging device 20. The operation of the solid-state imaging device 20 is controlled by a control signal inputted from a signal processing chip (DSP) 22. An output signal from the solid-state imaging device 20 is processed by the signal processing chip 22 and outputted as an image signal for TV monitor or for digital output.

The signal processing chip 22 includes a brightness processing portion 22a, a color processing portion 22b and an AD conversion portion 22c and operates based on a control signal from a micro controller 23. An EEPROM 24 supplies the micro controller 23 with information necessary for operating the signal processing chip 22.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An XY address type solid-state imaging device comprising:
a plurality of pixels that are arranged two-dimensionally;
a horizontal scanning circuit and a vertical scanning circuit that output a signal for reading out an accumulated charge in the pixel; and
a multiplexer circuit that supplies a control signal to elements constituting each of the pixels based on the signal outputted from the vertical scanning circuit;
wherein the vertical scanning circuit is used singly to output a scanning signal for reading out the accumulated charge and a scanning signal for clearing the accumulated charge in the pixel, and
the multiplexer circuit is used singly to supply an accumulated charge readout signal and an accumulated charge clearing signal as the control signal based on the scanning signal for reading out the accumulated charge and the scanning signal for clearing the accumulated charge.

2. The XY address type solid-state imaging device according to claim 1, comprising
a scanning purpose selecting circuit that is provided so as to correspond to each of scanning stages of the vertical scanning circuit and outputs selectively the signal outputted from the vertical scanning circuit as one of the scanning signal for reading out the accumulated charge and the scanning signal for clearing the accumulated charge based on a selection of one of a scanning for reading out the accumulated charge in the pixel and a scanning for clearing the accumulated charge in the pixel, and
a scanning signal time division circuit that is provided so as to correspond to each of the scanning stages of the vertical scanning circuit and outputs the accumulated charge readout signal and the accumulated charge clearing signal of the pixel to the multiplexer circuit by time division based on the scanning signal for reading out the accumulated charge and the scanning signal for clearing the accumulated charge outputted from the scanning purpose selecting circuit.

3. The XY address type solid-state imaging device according to claim 2, wherein the scanning purpose selecting circuit starts operating by an input of a scanning start signal of the vertical scanning circuit.

4. The XY address type solid-state imaging device according to claim 2, wherein the scanning purpose selecting circuit is scanned sequentially by using as a starting pulse the scanning signal for reading out the accumulated charge or the scanning signal for clearing the accumulated charge outputted from a scanning stage immediately before the scanning stage corresponding to said scanning purpose selecting circuit.

5. The XY address type solid-state imaging device according to claim 2, wherein the scanning purpose selecting circuit is scanned sequentially by using as a stopping pulse the scanning signal for reading out the accumulated charge or the scanning signal for clearing the accumulated charge outputted from a scanning stage immediately after the scanning stage corresponding to said scanning purpose selecting circuit.

6. The XY address type solid-state imaging device according to claim 2, wherein the scanning purpose selecting circuit corresponding to a scanning stage after a first scanning stage of the vertical scanning circuit incorporates a bootstrap circuit for suppressing attenuation of the accumulated charge readout signal and the accumulated charge clearing signal, and the accumulated charge readout signal or the accumulated charge clearing signal at a scanning stage immediately before the scanning stage corresponding to this scanning purpose selecting circuit is used as an input signal to the bootstrap circuit.

7. The XY address type solid-state imaging device according to claim 6, wherein the scanning purpose selecting circuit corresponding to the first scanning stage of the vertical scanning circuit also incorporates the bootstrap circuit, and a signal different from the accumulated charge readout signal or the accumulated charge clearing signal is supplied as the input signal for bootstrap.

8. The XY address type solid-state imaging device according to claim 2, wherein the scanning signal time division circuit is supplied with a row selection signal for driving selectively a pixel in a predetermined row in the plurality of pixels that is to be supplied to the multiplexer circuit, and a time division operation of the scanning signal time division circuit is controlled based on the row selection signal.

9. The XY address type solid-state imaging device according to claim 2, comprising a noise canceller circuit for removing a noise of an output signal of the pixels, wherein a sample hold pulse of the noise canceller circuit is inputted to the scanning signal time division circuit, and a time division operation of the scanning signal time division circuit is controlled based on the sample hold pulse.

10. The XY address type solid-state imaging device according to claim 1, wherein each of the plurality of pixels that are arranged two-dimensionally comprises four transistors consisting of a transfer transistor, a reset transistor, an amplification transistor and a row selection transistor, three signals of a reset signal, a transfer signal and a row selection signal are outputted from the multiplexer circuit in order to read out the accumulated charge in each of the pixels, and
the reset signal and the transfer signal are outputted from the multiplexer circuit in order to clear the accumulated charge in each of the pixels.

11. The XY address type solid-state imaging device according to claim 1, wherein each of the plurality of pixels that are arranged two-dimensionally comprises three transistors consisting of a transfer transistor, a reset transistor and an amplification transistor, and
a reset signal and a transfer signal are outputted from the multiplexer circuit in order to read out the accumulated charge and clear the accumulated charge in each of the pixels.

12. The XY address type solid-state imaging device according to claim 1, wherein all of the circuits are constituted by an N-type MOS transistor and an N-type MOS capacitor.

13. An imaging system comprising the XY address type solid-state imaging device according to claim 1.
